(19) United States
(12) Patent Application Publication
(10) Pub. No.: US 2020/0123057 A1
(43) Pub. Date: Apr. 23, 2020

(54) Resin Composition for Engineered Stone and Engineered Stone Formed Therefrom

(71) Applicant: LOTTE ADVANCED MATERIALS CO., LTD., Yeosu-si (KR)

(72) Inventors: Sung Jin AN, Uiwang-si (KR); Seul Gi BAE, Uiwang-si (KR); Chang Ho SON, Uiwang-si (KR)

(21) Appl. No.: 16/627,415

(22) PCT Filed: Jun. 12, 2018
(86) PCT No.: PCT/KR2018/006676

§ 371 Date: Dec. 30, 2019

(30) Foreign Application Priority Data
Jul. 31, 2017 (KR) 10-2017-0096849
Mar. 30, 2018 (KR) 10-2018-0037197

(51) Int. Cl. C04B 26/18; C04B 14/06; C04B 14/30; C01G 9/02

(52) U.S. Cl. CPC C04B 26/18; C04B 14/068; C04B 2103/67; C01G 9/02; C04B 14/30

(57) ABSTRACT

A resin composition for engineered stone according to the present invention is characterized by comprising: a matrix resin; an inorganic aggregate; and zinc oxide which has an average particle diameter of approximately 0.8 to approximately 3 μm, and in which the size ratio (B/A) between a 450 to 600 nm region peak B and a 370 to 390 nm region peak A as measured by photoluminescence is approximately 0.01 to approximately 1.0. The resin composition for engineered stone has excellent weather resistance and antibacterial properties.

### TECHNICAL FIELD

The present invention relates to a resin composition for engineered stone and an engineered stone formed of the same. More particularly, the present invention relates to a resin composition for engineered stone, which has good weather resistance and antibacterial properties, and an engineered stone formed of the same.

### BACKGROUND ART

Natural stone, such as granite and marble, has long been used as an architectural decoration due to a beautiful pattern thereof. Natural stone is a material having a high-quality texture, and demand therefor has thus increased in the fields of flooring, walls, sink tops, and the like. However, since expensive natural stone alone cannot meet this demand, various types of artificial stone have been developed.

Particularly, engineered stone (resin-based reinforced natural stone) is manufactured by compression molding of a resin composition prepared by mixing a natural mineral with a binder resin under vibration or vacuum/vibration conditions so as to have the texture of natural stone. Such engineered stone may be produced in a single color, may be produced by mixing resin mixtures including respective different color pigments to have multiple color tones, or may be produced using chips to have the texture of natural stone. In addition, the engineered stone can have a variety of colors and textures depending on the types of natural mineral and binder resin mixed together, the colors of pigments used, stirring conditions, and the like. Further, the engineered stone can have a very similar texture to natural stone and high hardness due to the main component thereof, that is, a natural mineral.

However, existing engineered stones still have a problem of poor weather resistance and are thus used in a very limited manner as an exterior material.

Therefore, there is a need for a resin composition for engineered stone, which can realize an engineered stone having improved properties in terms of weather resistance and the like without deterioration in mechanical properties.

The background technique of the present invention is disclosed in Korean Patent Publication No. 10-2011-0052425 and the like.

### DISCLOSURE

### Technical Problem

It is one aspect of the present invention to provide a resin composition for engineered stone, which has good weather resistance and antibacterial properties.

It is another aspect of the present invention to provide an engineered stone formed of the resin composition for engineered stone set forth above.

The above and other aspects of the present invention will become apparent from the detailed description of the following embodiments.

### Technical Solution

One aspect of the present invention relates to a resin composition for engineered stone. The resin composition for engineered stone includes: a matrix resin; an inorganic aggregate; and zinc oxide having an average particle diameter of about 0.8 μm to about 3 μm and a peak intensity ratio (B/A) of about 0.01 to about 1.0, where A indicates a peak in the wavelength range of 370 nm to 390 nm and B indicates a peak in the wavelength range of 450 nm to 600 nm in photoluminescence measurement.

In one embodiment, the resin composition may include: about 5 wt % to about 20 wt % of the matrix resin; about 40 wt % to about 94 wt % of the inorganic aggregate; and about 0.1 wt % to about 10 wt % of the zinc oxide.

In one embodiment, a weight ratio of the matrix resin to the inorganic aggregate may range from about 1:5 to about 1:18.

In one embodiment, a weight ratio of the zinc oxide to the inorganic aggregate may range from about 1:30 to about 1:500.

In one embodiment, the matrix resin may include at least one selected from the group of a polyester resin, an acrylic resin, an epoxy resin, and a polyurethane resin.

In one embodiment, the matrix resin may be an unsaturated polyester resin.

In one embodiment, the inorganic aggregate may be a silica-based natural mineral.

In one embodiment, the inorganic aggregate may include at least one selected from the group of silica sand, quartz chips, and silica powder.

In one embodiment, the inorganic aggregate may include about 20 wt % to about 75 wt % of the silica sand, about 0.1 wt % to about 40 wt % of the quartz chips, and about 20 wt % to about 40 wt % of the silica powder.

In one embodiment, the resin composition may further include at least one selected from the group of a curing agent, a curing accelerator, a silane coupling agent, and a pigment.

In one embodiment, the resin composition may have a color variation (ΔE) of about 2 to about 7, as calculated according to Equation 1 based on initial color values (L₀*, a₀*, b₀*) measured on an injection-molded specimen having a size of 50 mm×90 mm×3 mm using a colorimeter and color values (L₁*, a₁*, b₁*) of the specimen measured using the colorimeter after weather resistance testing for 3,000 hours in accordance with SAE J 1960.

Color variation (ΔE)=\sqrt{(ΔL*)²+(Δa*)²+(Δb*)²}, [Equation 1]

where ΔL* is a difference (L₁*−L₀*) between L* values before and after weather resistance testing, Δa* is a difference (a₁*−a₀*) between a* values before and after weather resistance testing, and Δb* is a difference (b₁*−b₀*) between b* values before and after weather resistance testing.

Another aspect of the present invention relates to an engineered stone formed of the resin composition for engineered stone set forth above.

### Advantageous Effects

The present invention provides a resin composition for engineered stone, which has good weather resistance and antibacterial properties, and an engineered stone formed of the same.

### BEST MODE

Hereinafter, embodiments of the present invention will be described in detail.

A resin composition for engineered stone according to the present invention includes: (A) a matrix resin; (B) an inorganic aggregate; and (C) zinc oxide.

(A) Matrix Resin

The matrix resin according to one embodiment of the present invention may include any matrix resin used in known engineered stones (resin-based reinforced natural stones) without limitation. For example, the matrix resin may include an (unsaturated) polyester resin, an acrylic resin, an epoxy resin, a polyurethane resin, and combinations thereof, specifically, an unsaturated polyester resin and an acrylic resin.

In some embodiments, the (unsaturated) polyester resin may be prepared by condensation of an α,β-unsaturated dibasic acid or a mixture of the dibasic acid and a saturated dibasic acid with a polyhydric alcohol. For example, the polyester resin may be prepared by mixing the α,β-unsaturated dibasic acid with the polyhydric alcohol in a specific ratio (for example, mole number of alcoholic hydroxyl groups/mole number of carboxyl groups: about 0.8 to about 1.2), followed by condensation of the mixture in a reactor at a temperature of 140° C. to 250° C. under a stream of an inert gas, such as carbon dioxide gas and nitrogen gas, while removing produced water and gradually increasing the temperature of the reactor depending on the progress of reaction, without being limited thereto.

Here, examples of the α,β-unsaturated dibasic acid and the saturated dibasic acid may include maleic anhydride, citraconic acid, fumaric acid, itaconic acid, phthalic acid, phthalic anhydride, isophthalic acid, terephthalic acid, succinic acid, adipic acid, sebacic acid, tetrahydrophthalic acid, and combinations thereof, and examples of the polyhydric alcohol may include ethylene glycol, diethylene glycol, triethylene glycol, propylene glycol, dipropylene glycol, tripropylene glycol, polypropylene glycol, 1,3-butylene glycol, hydrogenated bisphenol-A, neopentyl glycol, 2,2,4-trimethyl-1,3-pentanediol, glycerin, and combinations thereof. The polyester resin may further include: a monobasic acid such as acrylic acid, propionic acid, and benzoic acid; or a polybasic acid such as trimellitic acid and tetracarboxylic acid of benzol, as needed.

In some embodiments, the polyester resin may have a weight average molecular weight of about 1,000 g/mol to about 10,000 g/mol, for example, about 1,500 g/mol to about 4,000 g/mol, as measured by gel permeation chromatography (GPC). Within this range, the resin composition for engineered stone can have good processability.

In some embodiments, the acrylic resin may be a polymer of a (meth)acrylic monomer, for example, a polymer of a monomer (or a monomer mixture) including methyl (meth)acrylate, ethyl (meth)acrylate, butyl (meth)acrylate, 2-ethylhexyl (meth)acrylate, benzyl (meth)acrylate, glycidyl (meth)acrylate, and combinations thereof, without being limited thereto.

In some embodiments, the acrylic resin may have a weight average molecular weight of about 10,000 g/mol to about 150,000 g/mol, for example, about 30,000 g/mol to about 100,000 g/mol, as measured by gel permeation chromatography (GPC). Within this range, the resin composition for engineered stone can have good processability.

In addition, the epoxy resin may include a bisphenol-A epoxy resin, a bisphenol-S epoxy resin, a tetraphenylethane epoxy resin, a phenol novolac epoxy resin, and mixtures thereof, without being limited thereto.

In some embodiments, the matrix resin may be present in an amount of about 5 wt % to about 20 wt %, for example, about 6 wt % to about 13 wt %, specifically about 7 wt % to about 10 wt %, based on the total weight of the resin composition. Within this range, the resin composition for engineered stone can have good flowability and an engineered stone formed of the resin composition can have good properties in terms of processability and appearance characteristics (color and the like).

(B) Inorganic Aggregate

The inorganic aggregate according to one embodiment of the present invention is used to imitate the appearance and texture of natural stone, and may include any inorganic aggregate used in known engineered stones (resin-based reinforced natural stones) without limitation.

In some embodiments, the inorganic aggregate may include a silica-based natural mineral, for example, silica sand, quartz chips, silica powder and combinations thereof.

In some embodiments, the inorganic aggregate may include about 20 wt % to about 75 wt %, for example about, 30 wt % to about 55 wt % of the silica sand, about 0.1 wt % to about 40 wt %, for example about 7 wt % to about 20 wt % of the quartz chips, and about 20 wt % to about 40 wt %, for example about 20 wt % to about 28 wt % of the silica powder. Within these ranges, the resin composition for engineered stone can realize a more similar appearance and texture to natural stone.

In some embodiments, the silica sand may have an average particle diameter of about 0.1 mm to about 1.5 mm, for example, about 0.1 to about 1.2 mm, as measured by a sieving method (apparatus); the quartz chips may have an average particle diameter (based on major diameter) of about 0.5 mm to about 10 mm, for example, about 1.3 mm to about 9 mm; and the silica powder may have an average particle diameter of about 5 μm to about 50 μm, for example, about 10 μm to about 45 μm. Within this range, the inorganic aggregate can be easily mixed with the matrix resin while preventing formation of voids upon mixing with the matrix resin, and the resin composition for engineered stone can realize a similar appearance and texture to natural stone.

In some embodiments, the inorganic aggregate may have a Mohs hardness of greater than about 3 and less than or equal to about 9, for example, about 6 to about 8. Within this range, an engineered stone formed of the resin composition can have good properties in terms of surface hardness, processability, and crack resistance.

In some embodiments, the inorganic aggregate may be present in an amount of about 40 wt % to about 94 wt %, for example, about 75 wt % to about 90 wt %, specifically about 80 wt % to about 90 wt %, based on the total weight of the resin composition. Within this range, the resin composition for engineered stone can have good flowability and an engineered stone formed of the resin composition can have good properties in terms of processability and appearance characteristics (color and the like).

In some embodiments, the matrix resin (A) and the inorganic aggregate (B) may be present in a weight ratio ((A):(B)) of about 1:5 to about 1:18, for example, about 1:6 to about 1:15, specifically about 1:7 to about 1:14. Within this range, an engineered stone formed of the resin composition can have further improved properties in terms of processability and appearance characteristics.

(C) Zinc Oxide

The zinc oxide according to one embodiment of the present invention serves to improve weather resistance and antibacterial properties of the resin composition for engineered stone, and may have an average particle size (D50) of about 0.8 μm to about 3 μm, for example, about 1 μm to about 3 μm, as measured using a particle size analyzer, and a peak intensity ratio (B/A) of about 0.01 to about 1.0, for example, about 0.1 to about 1.0, specifically about 0.2 to about 0.8, where A indicates a peak in the wavelength range of 370 nm to 390 nm and B indicates a peak in the wavelength range of 450 nm to 600 nm in photoluminescence measurement. If the peak intensity ratio (B/A) of the zinc oxide is less than about 0.01, the resin composition can have poor antibacterial properties. If the peak intensity ratio (B/A) of the zinc oxide exceeds about 1.0, the resin composition can have poor weather resistance.

In some embodiments, the zinc oxide may have a BET specific surface area of about 10 m²/g or less, for example, about 1 m²/g to about 7 m²/g, and a purity of about 99% or more. Within this range, the resin composition can have good mechanical properties and discoloration resistance. If the BET specific surface area of the zinc oxide exceeds about 10 m²/g, the resin composition cannot secure a desired level of weather resistance.

In some embodiments, the zinc oxide may have a peak position degree (2θ) in the range of about 35° to about 37° and a crystallite size of about 1,000 Å to about 2,000 Å, for example, about 1,200 Å to about 1,800 Å, in X-ray diffraction (XRD) analysis, as calculated by Scherrer's equation (Equation 2) with reference to a measured FWHM value (full width at half maximum of a diffraction peak). Within this range, the resin composition can have good initial color, weather resistance (discoloration resistance), antibacterial properties, and balance therebetween.

$$\text{Crystallite size} ( D ) = \frac{K λ}{β cos θ} , \qquad [ Equation 2 ]$$

where K is a shape factor, λ is an X-ray wavelength, β is an FWHM value (degree) of an X-ray diffraction peak, and θ is a peak position degree.

In some embodiments, the zinc oxide may be prepared by melting metallic zinc in a reactor, heating the molten zinc to about 850° C. to about 1,000° C., for example, about 900° C. to about 950° C., to vaporize the molten zinc, injecting oxygen gas into the reactor, cooling the reactor to about 20° C. to about 30° C., and heating the reactor to about 400° C. to about 900° C., for example, about 500° C. to about 800° C., for about 30 minutes to about 150 minutes, for example, 60 minutes to about 120 minutes.

In some embodiments, the zinc oxide may be present in an amount of about 0.1 wt % to about 10 wt %, for example, about 0.3 wt % to about 5 wt %, specifically about 0.5 wt % to about 2 wt %, based on the total weight of the resin composition. Within this range, the resin composition for engineered stone can have good weather resistance and antibacterial properties.

In some embodiments, the zinc oxide (C) and the inorganic aggregate (B) may be present in a weight ratio ((C):(B)) of about 1:30 to about 1:500, for example, about 1:30 to about 1:300, specifically about 1:40 to about 1:200. Within this range, an engineered stone formed of the resin composition can have further improved weather resistance, antibacterial properties, processability, appearance characteristics, and balance therebetween.

The resin composition for engineered stone according to one embodiment of the present invention may further include additives including a curing agent, a curing accelerator, a silane coupling agent, a pigment, a mineral, and combinations thereof.

The additives may include any additive used in known resin compositions for engineered stone (compositions for resin-based reinforced natural stone) without limitation. Examples of the curing agent may include t-butyl peroxybenzoate (TBPB), methyl ethyl ketone peroxide (MEKPO), and a combination thereof; examples of the curing accelerator may include a cobalt-based curing accelerator and the like; and examples of the pigment may include a reddish brown pigment such as iron oxide, a yellow pigment such as iron hydroxide, a green pigment such as chromium oxide, an ultramarine pigment such as sodium aluminosilicate, a white pigment such as titanium oxide, a black pigment such as carbon black, an azo pigment, a phthalocyanine pigment, and, optionally, pearl, without being limited thereto.

In addition, the mineral serves to improve crack resistance of an engineered stone formed of the resin composition, and may include talc, gypsum, calcite, and combinations thereof, preferably talc.

In some embodiments, the mineral may have a Mohs hardness of about 1 to about 3 and an average particle diameter of about 1 μm to about 50 μm, for example, about 5 μm to about 45 μm, as measured using a particle size analyzer. Within these ranges, an engineered stone formed of the resin composition can have good properties in terms of surface hardness and crack resistance.

For example, each of the additives may be present in an amount of about 0.1 parts by weight to about 30 parts by weight relative to about 100 parts by weight of the matrix resin although the amount of the additives are not particularly restricted unless causing deterioration in desired properties provided by the present invention.

In one embodiment, the resin composition for engineered stone may have a color variation (ΔE) of about 2 to about 7, for example, about 2 to about 5, as calculated according to Equation 1 based on initial color values (L₀*, a₀*, b₀*) measured on an injection-molded specimen having a size of 50 mm×90 mm×3 mm using a colorimeter and color values (L₁*, a₁*, b₁*) of the specimen measured using the colorimeter after weather resistance testing for 3,000 hours in accordance with SAE J 1960. Within this range, an engineered stone formed of the resin composition can have good weather resistance.

Color variation (ΔE)=\sqrt{(ΔL*)²+(Δa*)²+(Δb*)²}, [Equation 1]

where ΔL* is a difference (L₁*−L₀*) between L* values before and after weather resistance testing, Δa* is a difference (a₁*−a₀*) between a* values before and after weather resistance testing, and Δb* is a difference (b₁*−b₀*) between b* values before and after weather resistance testing.

An engineered stone according to the present invention is formed of the resin composition for engineered stone set forth above. For example, the engineered stone may be manufactured (molded) using the resin composition by any known engineered stone manufacturing method. Specifically, the engineered stone may be manufactured by mixing (stirring) the aforementioned components of the resin composition, followed by compression molding and curing under vibration or vacuum/vibration conditions and, optionally, surface polishing. Since this process is well known in the art, detailed description thereof will be omitted.

### MODE FOR INVENTION

Next, the present invention will be described in more detail with reference to some examples. It should be understood that these examples are provided for illustration only and are not to be in any way construed as limiting the present invention.

Description of details that can be easily conceived by those skilled in the art will be omitted for clarity.

### EXAMPLE

Details of components used in Examples and Comparative Examples are as follows:

(A) Matrix Resin

An unsaturated polyester resin (manufacturer: Aekyung Chemical Co., Ltd., product name: ATM100) having a weight average molecular weight of 2,500 g/mol was used.

(B) Inorganic Aggregate

(B1) Silica sand (manufacturer: Microman Co., Ltd., average particle diameter: 0.6 mm) was used.

(B2) Quartz chips (manufacturer: 21Century Silica Ltd., average particle diameter: 4 mm) were used.

(B3) Silica powder (manufacturer: 21Century Silica Ltd., average particle diameter: 10 μm) was used.

(C) Zinc Oxide

(C1) After metallic zinc was melted in a reactor, the molten zinc was heated to 850° C. to be vaporized and then oxygen gas was injected into the reactor, followed by cooling to room temperature (25° C.), thereby obtaining a primary intermediate product. Then, the primary intermediate product was subjected to heat treatment at 700° C. for 90 minutes, followed by cooling to room temperature (25° C.), thereby preparing zinc oxide.

(C2) Zinc oxide (manufacturer: RISTec-Biz Co., Ltd., product name: RZ-950) was used.

(C3) Zinc oxide (manufacturer: Wako Pure Chemical, product name: 264-00365) was used.

The zinc oxides (C1, C2, and C3) were measured as to average particle size, BET surface area, purity, crystallite size, and peak intensity ratio (B/A) where A indicates a peak in the wavelength range of 370 nm to 390 nm and B indicates a peak in the wavelength range of 450 nm to 600 nm in photoluminescence measurement. Results are shown in Table 1.

TABLE 1

| | (C1) | (C2) | (C3) |
|---|---|---|---|
| Average particle | 1.2 | 1.1 | 1.3 |
| diameter (μm) | | | |
| BET surface area | 4 | 15 | 5 |
| (m²/g) | | | |
| Purity (%) | 99 | 97 | 99 |
| PL peak intensity | 0.28 | 9.8 | 0.0016 |
| ratio (B/A) | | | |
| Crystallite size (Å) | 1,417 | 503 | 1,870 |

Property Evaluation

(1) Average particle diameter (unit: μm): Average particle diameter (volume average) was measured using a particle size analyzer (Laser Diffraction Particle Size Analyzer LS 13 320, Beckman Coulter Co., Ltd.).

(2) BET surface area (unit: m²/g): BET surface area was measured by a nitrogen gas adsorption method using a BET analyzer (Surface Area and Porosity Analyzer ASAP 2020, Micromeritics Co., Ltd.).

(3) Purity (unit: %): Purity was measured by thermogravimetric analysis (TGA) based on the weight of remaining material at 800° C.

(4) PL peak intensity ratio (B/A): Spectrum emitted upon irradiation of a specimen using a He-Cd laser (KIMMON, 30 mW) at a wavelength of 325 nm at room temperature was detected by a CCD detector in a photoluminescence measurement method, in which the CCD detector was maintained at −70° C. A peak intensity ratio (B/A) of peak B in the wavelength range of 450 nm to 600 nm to peak A in the wavelength range of 370 nm to 390 nm was measured. Here, an injection molded specimen was irradiated with laser beams without separate treatment upon PL analysis, and zinc oxide powder was compressed in a pelletizer having a diameter of 6 mm to prepare a flat specimen.

(5) Crystallite size (unit: Å): Crystallite size was measured using a high-resolution X-ray diffractometer (PRO-MRD, X'pert Inc.) at a peak position degree (2θ) in the range of 35° to 37° and calculated by Scherrer's equation (Equation 2) with reference to a measured FWHM value (full width at half maximum of a diffraction peak). Here, both a powder form and an injection molded specimen could be measured. For more accurate analysis, the injection molded specimen was subjected to heat treatment in air at 600° C. for 2 hours to remove a polymer resin therefrom before XRD analysis.

$$\text{Crystallite size} ( D ) = \frac{K λ}{β cos θ} , \qquad [ Equation 2 ]$$

where K is a shape factor, λ is an X-ray wavelength, β is an FWHM value (degree) of an X-ray diffraction peak, and θ is a peak position degree.

### Examples 1 to 3 and Comparative Examples 1 to 3

First, the matrix resin (A), the inorganic aggregate (B), and the zinc oxide (C) were mixed in amounts as listed in Table 2. Then, relative to 100 parts by weight of the matrix resin, 2 parts by weight of a curing agent (t-butyl peroxybenzoate (TBPB), manufacturer: SEKI ARKEMA Co., Ltd.), 0.2 parts by weight of a curing accelerator (6% cobalt-octoate, manufacturer: Jinyang Chemical Co., Ltd.), 1 part by weight of silane coupling agent (manufacturer: Gudam Co., Ltd., product name: WD-70), and 5 parts by weight of a pigment (TiO₂, manufacturer: Woosin Pigment Co., Ltd., product name: HUNTSMAN TR92) were added to and mixed with the mixture, thereby obtaining a resin composition for engineered stone. Thereafter, the resin composition was placed in a mold having a size of 300 mm×300 mm×100 mm, and the mold was then vertically vibrated at a motor speed of 3,600 rpm for 2 minutes, followed by compression molding at a pressure of 2 bar to 3 bar under a vacuum of −760 mmHg, and then the resulting resin was subjected to curing at 90° C. for 1 hour, thereby manufacturing an engineered stone. The manufactured engineered stone was evaluated as to weather resistance, antibacterial properties, and the like. Results are shown in Table 2.

Property Evaluation

(1) Weather resistance (color variation (ΔE)): For determination of color variation, initial color values L₀*, a₀* and b₀* were measured on an injection molded specimen having a size of 50 mm×90 mm×3 mm using a colorimeter and then the injection molded specimen was subjected to weather resistance testing for 3,000 hours in accordance with SAE J 1960, followed by measurement of color values L₁*, a₁* and b₁* of the specimen using the colorimeter. Thereafter, a color variation (ΔE) was calculated according to Equation 1.

Color variation (ΔE)=\sqrt{(ΔL*)²+(Δa*)²+(Δb*)²}, [Equation 1]

where ΔL* is a difference (L₁*−L₀*) between L* values before and after weather resistance testing, Δa* is a difference (a₁*−a₀*) between a* values before and after weather resistance testing, and Δb* is a difference (b₁*−b₀*) between b* values before and after weather resistance testing.

(2) Antibacterial activity: In accordance with JIS Z 2801, 5 cm×5 cm specimens were inoculated with Staphylococcus aureus and Escherichia coli, respectively, and then subjected to culturing under conditions of 35° C. and 90% RH for 24 hours, followed by calculation of antibacterial activity according to Equation 3:

Antibacterial activity=log(M1/M2), [Equation 3]

where M1 is the number of bacteria as measured on a blank specimen after culturing for 24 hours and M2 is the number of bacteria as measured on each of the specimens after culturing for 24 hours.

(3) Flexural strength (unit: MPa): Flexural strength was measured in accordance with ASTM D790-07E1.

(4) Scratch resistance: After an engineered stone specimen was subjected to surface polishing with a grinding wheel (grade: #50 to #2500) for 3 minutes using a polishing machine (manufacturer: Sungchang Machinery Co., Ltd.), it was observed whether scratches occurred on the surface of the specimen. When one or more scratches occurred, a corresponding specimen was rated as “unsuitable”, and, when no scratches occurred, a corresponding specimen was rated as “suitable”.

TABLE 2

| | | Example | | | Comparative Example | | |
|---|---|---|---|---|---|---|---|
| | | 1 | 2 | 3 | 1 | 2 | 3 |
| (A) (wt %) | | 10 | 10 | 10 | 10 | 10 | 10 |
| (B) (wt %) | (B1) | 50 | 50 | 50 | 50 | 50 | 50 |
| | (B2) | 13 | 13 | 13 | 13 | 13 | 13 |
| | (B3) | 26.5 | 26 | 25 | 26 | 26 | 26 |
| (C) (wt %) | (C1) | 0.5 | 1 | 2 | — | — | — |
| | (C2) | — | — | — | 1 | — | — |
| | (C3) | — | — | — | — | 1 | — |

| | | | | | | |
|---|---|---|---|---|---|---|
| Color variation (ΔE) | 3.2 | 2.5 | 2.4 | 8.5 | 9.1 | 9.0 |
| Antibacterial activity | 5.7 | 6.3 | 6.3 | 6.3 | 6.3 | 0.3 |
| (Escherichia coli) | | | | | | |
| Antibacterial activity | 4.6 | 4.6 | 4.6 | 4.6 | 4.6 | 0.2 |
| (Staphylococcus aureus) | | | | | | |
| Flexural strength (MPa) | 86 | 85 | 84 | 67 | 84 | 86 |
| Scratch resistance | Suit- | Suit- | Suit- | Suit- | Unsuit- | Suit- |
| | able | able | able | able | able | able |

From the results shown in Table 2, it can be seen that the resin composition for engineered stone and the engineered stone according to the present invention (Examples 1 to 3) exhibited good weather resistance, antibacterial properties, flexural strength, and scratch resistance.

On the contrary, the resin composition of Comparative Example 1, including the zinc oxide (C2) having a peak intensity ratio (B/A) of 9.8 (exceeding 1.0), exhibited poor properties in terms of weather resistance and flexural strength, and the resin composition of Comparative Example 2, including the zinc oxide (C3) having a peak intensity ratio (B/A) of 0.0016 (less than 0.01), exhibited poor properties in terms of weather resistance and scratch resistance. In addition, the resin composition of Comparative Example 3, free from the zinc oxide, exhibited poor weather resistance and antibacterial properties.

It should be understood that various modifications, changes, alterations, and equivalent embodiments can be made by those skilled in the art without departing from the spirit and scope of the invention.

1. A resin composition for engineered stone, comprising:
a matrix resin;
an inorganic aggregate; and
zinc oxide having an average particle diameter of about 0.8 μm to about 3 μm and a peak intensity ratio (B/A) of about 0.01 to about 1.0, where A indicates a peak in the wavelength range of 370 nm to 390 nm and B indicates a peak in the wavelength range of 450 nm to 600 nm in photoluminescence measurement.

2. The resin composition according to claim 1, comprising: about 5 wt % to about 20 wt % of the matrix resin; about 40 wt % to about 94 wt % of the inorganic aggregate; and about 0.1 wt % to about 10 wt % of the zinc oxide.

3. The resin composition according to claim 1, wherein a weight ratio of the matrix resin to the inorganic aggregate ranges from about 1:5 to about 1:18.

4. The resin composition according to claim 1, wherein a weight ratio of the zinc oxide to the inorganic aggregate ranges from about 1:30 to about 1:500.

5. The resin composition according to claim 1, wherein the matrix resin comprises a polyester resin, an acrylic resin, an epoxy resin, and/or a polyurethane resin.

6. The resin composition according to claim 1, wherein the matrix resin is an unsaturated polyester resin.

7. The resin composition according to claim 1, wherein the inorganic aggregate is a silica-based natural mineral.

8. The resin composition according to claim 1, wherein the inorganic aggregate comprises silica sand, quartz chips, and/or silica powder.

9. The resin composition according to claim 8, wherein the inorganic aggregate comprises about 20 wt % to about 75 wt % of the silica sand, about 0.1 wt % to about 40 wt % of the quartz chips, and about 20 wt % to about 40 wt % of the silica powder.

10. The resin composition according to claim 1, further comprising:
a curing agent, a curing accelerator, a silane coupling agent, and/or a pigment.

11. The resin composition according to claim 1, wherein the resin composition has a color variation (ΔE) of about 2 to about 7, as calculated according to Equation 1 based on initial color values (L₀*, a₀*, b₀*) measured on an injection-molded specimen having a size of 50 mm×90 mm×3 mm using a colorimeter and color values (L₁*, a₁*, b₁*) of the specimen measured using the colorimeter after weather resistance testing for 3,000 hours in accordance with SAE J 1960;
Color variation (ΔE)={square root over (ΔL*)²+(Δa*)²+(Δb*)²)}, [Equation 1]
where ΔL* is a difference (L₁*−L₀*) between L* values before and after weather resistance testing, Δa* is a difference (a₁*−a₀*) between a* values before and after weather resistance testing, and Δb* is a difference (b₁*−b₀*) between b* values before and after weather resistance testing.

12. An engineered stone formed of the resin composition for engineered stone according to claim 1.
